(19) United States
(12) Patent Application Publication
(10) Pub. No.: US 2019/0256104 A1
(43) Pub. Date: Aug. 22, 2019

(54) DRIVER ASSISTANCE CONTROL DEVICE OF A VEHICLE, DRIVER ASSISTANCE CONTROL METHOD OF A VEHICLE AND DRIVER ASSISTANCE SYSTEM

(71) Applicant: DENSO CORPORATION, Kariya-city (JP)

(72) Inventors: Shun SHIMIZU, Kariya-city (JP); Daiji WATANABE, Kariya-city (JP)

(21) Appl. No.: 16/276,089

(22) Filed: Feb. 14, 2019

(30) Foreign Application Priority Data
Feb. 19, 2018 (JP) 2018-027037

(51) Int. Cl. B60W 50/00; B60W 30/182; B60W 30/12; B60W 30/14; B60W 30/09

(52) U.S. Cl. CPC B60W 50/0098; B60W 30/182; B60W 30/12; B60W 2420/42; B60W 30/09; B60W 2540/22; B60W 2420/52; B60W 30/143

(57) ABSTRACT

A driver assistance control device for a vehicle is provided. The driver assistance control device comprises an acquiring unit that acquires detected driving conditions of a vehicle and driving environment of the vehicle, and a control unit that determines a mode of driver assistance depending on at least one of the acquired driving conditions and the driving environment and make the driver assistance units execute the driver assistance in accordance with the determined mode of driver assistance. When the mode of the driver assistance is changed, the control unit reduces the change in the mode of the driver assistance for a predetermined first transition period. This keeps a balance between suppressing behavior change of a vehicle and rapidly switching the modes of driver assistance.

### CROSS-REFERENCE TO RELATED APPLICATION

This application is based on and claims the benefit of priority from earlier Japanese Patent Application No. 2018-27037 filed Feb. 19, 2018, the description of which is incorporated herein by reference.

### BACKGROUND OF THE INVENTION

### Technical Field of the Invention

The present disclosure relates to a technique for controlling driver assistance of a vehicle.

### Related Art

Japanese Unexamined Patent Application Publication No. 2016-68684 teaches a driver assistance control technology that assists people with driving a vehicle using the driving conditions of the vehicle and driving environment of the vehicle. When the behavior of the vehicle associated with the driver assistance control does not match the intention of the driver, the driver senses discomfort. Thus, for example, in the technique of adaptive cruise control, which is a mode of driver assistance, a technique of changing the degree of acceleration or deceleration depending on environment outside the vehicle has been proposed.

However, even when switching the modes of driver assistance, when a change in behavior of the vehicle is not smooth, a problem of giving the driver and others in the vehicle a sense of discomfort or anxiety arises. On the other hand, switching the modes of driver assistance is determined on the basis of the driving conditions of the vehicle and the driving environment of the vehicle, and prompt switching is desired.

### SUMMARY OF THE INVENTION

It is, therefore, an object of this disclosure to provide a driver assistance control apparatus designed to keep a balance between suppressing behavior change of a vehicle and rapidly switching modes of driver assistance.

A first aspect provides a driver assistance control device of a vehicle. The driver assistance control device comprises: (a) an acquiring unit that acquires detected driving conditions of the vehicle and driving environment of the vehicle; and (b) a control unit that determines a mode of driver assistance depending on at least one of the acquired driving conditions and the driving environment and makes a driver assistance unit execute driver assistance in accordance with the determined mode of the driver assistance.

When the mode of the driver assistance is changed, the control unit reduces the change of the mode of the driver assistance for a predetermined first transition period.

According to the driver assistance control device of a vehicle according to the first aspect, it is possible to keep a balance between suppressing behavior change of the vehicle and rapidly switching the modes of the driver assistance.

A second aspect provides a driver assistance system. The driver assistance system according to the second aspect comprises the driver assistance control device according to the first aspect, a detection unit that detects driving conditions of the vehicle and a driving environment of the vehicle, and the driver assistance units.

According to the driver assistance system according to the second aspect, it is possible to keep a balance between suppressing behavior change of a vehicle and rapidly switching the mode of the driver assistance.

A third aspect provides a method for the driver assistance control of a vehicle. The method for the driver assistance control of a vehicle according to the third aspect comprises the steps of: acquiring the detected driving conditions of the vehicle and the driving environment of the vehicle; and determining the mode of the driver assistance depending on at least one of the acquired driving conditions and the driving environment. When the determined mode of the driver assistance is changed, the change of the mode of the driver assistance is reduced for a first transition period, and making the driver assistance unit execute the driver assistance in accordance with the determined mode of the driver assistance.

According to the method for setting control target vehicle according to the third aspect, it is possible to keep a balance between suppressing behavior change of a vehicle and rapidly switching the modes of the driver assistance. Further, the present disclosure can also be achieved as a program for the driver assistance control of a vehicle, or as a computer readable recording medium that stores the program.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

FIG. 1 is an illustration diagram of a vehicle provided with the driver assistance control device according to the first embodiment.

FIG. 2 is a block diagram showing a functional constitution of the driver assistance control device according to the first embodiment.

FIG. 3 is a flow chart showing the flow of processes of the driver assistance control process executed by the driver assistance control device according to the first embodiment.

FIG. 4 is a first illustration diagram showing a modification of the mode of the driver assistance between an assistance process for keeping inter-vehicle distance and vehicle speed and an assistance process for constant speed driving.

FIG. 5 is a second illustration diagram showing a modification of the mode of the driver assistance between the assistance process for keeping inter-vehicle distance and vehicle speed and the assistance process for constant speed driving.

FIG. 6 is a third illustration diagram showing a modification of the mode of the driver assistance between the assistance process for keeping inter-vehicle distance and vehicle speed and the assistance process for constant speed driving.

FIG. 7 is a first illustration diagram showing a modification of the mode of the driver assistance between an assistance process for preventing lane departure and an assistance process for changing lanes.

FIG. 8 is a second illustration diagram showing a modification of the mode of the driver assistance between the assistance process for preventing lane departure and the assistance process for changing lanes.

FIG. 9 is an illustration diagram showing change patterns of the mode of the driver assistance in the first embodiments.

FIG. 10 is an illustration diagram showing an example of time change of acceleration at the time of executing and not executing the ease process on change of the mode of the driver assistance.

FIG. 11 is a functional block diagram showing an example of applying a low pass filter to a control value calculated depending on the driver assistance determined using driving conditions and driving environment.

FIG. 12 is a functional block diagram showing an example of applying a low pass filter to detection values of driving conditions and driving environment used to calculate the control value.

### DESCRIPTION OF THE PREFERRED EMBODIMENTS

The driver assistance control device, the driver assistance system, and the method for driver assistance control according to the present disclosure will be described below based on several embodiments.

### First Embodiment

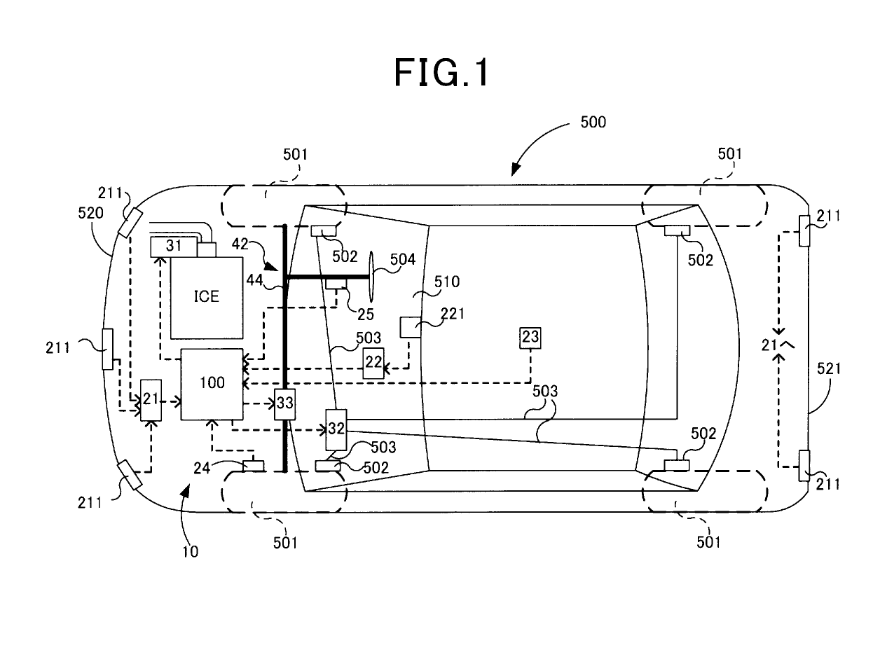

As shown in FIG. 1, the driver assistance control device 100 according to the first embodiment is mounted on a vehicle 500 (which will also be referred to as a system-equipped vehicle equipped with the drive assistance control device 100). The driver assistance system 100 includes at least control unit and an acquiring unit. In addition to the driver assistance control device 100, the driver assistance system 10 is provided with a radar ECU 21, a camera ECU 22, a yaw rate sensor 23, a wheel speed sensor 24, a rotation angle sensor 25, an output control device 31, a braking assistance device 32 and a steering assistance device 33. The vehicle 500 is provided with an internal combustion engine ICE, wheels 501, a braking device 502, a braking line 503, a steering wheel 504, a windshield 510, and a front bumper 520. The radar ECU 21 is connected to a millimeter wave radar 211 that emits radio waves and detects the waves reflected from a target, and generates and delivers a detection signal representing the target by the reflection point using the reflected wave acquired by the millimeter wave radar 211. The camera ECU 22 is connected to a camera 221, and generates and delivers a detection signal showing the target by an image using an image acquired with the front camera 221 and a shape pattern of the target prepared in advance. Each ECU is a microprocessor provided with a computing unit, a storage unit, and an input/output unit. Further, the radar ECU 21 and the millimeter wave radar 211, and the camera ECU 22 and the camera 221 correspond to the detection unit. As for the detector for detecting the reflected wave, in addition to the millimeter wave radar 211, a lidar (LIDAR: laser radar) or an ultrasonic detector that emits sound waves and detects the reflected waves thereof may be used. As an imaging device for imaging the target, other than the monocular camera 221, a stereo camera constituted by two or more cameras or a binocular camera may be used.

In the vehicle 500, the internal combustion engine ICE is provided with an output control device 31 for controlling the output of the internal combustion engine ICE. The output control device 31 comprises a throttle driving device that drives a throttle valve for controlling the output of the internal combustion engine ICE by adjusting the intake air amount, and a fuel injection driving device that drives a fuel injection device. Further, in the case where a diesel engine having a constant intake air amount is provided as an internal combustion engine ICE, the output is controlled by the fuel injection driving device. Furthermore, an electric motor may be used as a power source for driving in place of the internal combustion engine ICE, and in this case, an inverter and a converter can be used as the output control device 31. The output control device 31 is included in a driver assistance unit that executes driver assistance.

The braking device 502 is provided for each wheel 501. Each braking device 502 achieves braking of each wheel 501 using brake hydraulic pressure supplied via the braking line 503 in response to the operation of the driver's brake pedal. The brake line 503 comprises a brake piston that generates the brake hydraulic pressure in response to a brake pedal operation, and a brake fluid line. In the present embodiment, the braking assistance device 32 is provided in the braking line 503, and hydraulic pressure control is possible by an actuator such as an electric motor independently of the brake pedal operation, whereby braking assistance is achieved. Further, as for the braking line 503, a constitution may be adopted where a control signal line is used in place of the brake fluid line, and the actuator provided in each braking device 502 is operated. The braking assistance device 32 is provided in the driver assistance unit that executes driver assistance.

The steering wheel 504 is connected to the front wheel 501 via a steering device 44 having a steering rod and a steering mechanism. In the steering device 44, a steering assistance device 33 capable of driving the steering device 44 by an actuator, for example, an electric motor, is disposed. The steering assistance device 33 is capable of controlling driving of the steering device 44 independently of the operation of the steering wheel 504, thereby achieving steering assistance in accordance with the detection results obtained by the camera 221 and each millimeter wave radar 211. The steering assistance device 33 can also function as a steering force auxiliary device for assisting the steering force by the steering wheel 504 and easing the steering force. The steering assistance device 33 is provided in the driver assistance unit that executes driver assistance.

By the output control device 31 and the braking assistance device 32, a vehicle speed and inter-vehicle distance keeping control process, namely an adaptive cruise control (ACC) mode in which the system-equipped vehicle 500 is driven at a preset speed while keeping the inter-vehicle distance between the preceding vehicle and the system-equipped vehicle 500 at a constant value, is achieved as a driver assistance control mode. Moreover, by the braking assistance device 32 and the steering assistance device 33, an assistance process for keeping a driving lane that keeps the driving lane of the system-equipped vehicle 500, i.e., a lane keeping assist mode (also called a lane tracing assist mode) or a lane departure control mode (also called a lane departure alert mode) and assistance process for changing driving lanes that assists driving lane change of the system-equipped vehicle 500, namely lane change assist mode are achieved as driver assistance control modes. One or two of these driver assist modes are selected depending on the driving conditions of the vehicle 500 and the driving environment surrounding the vehicle 500 detected via the millimeter wave radar 211 and the camera 221 as detection units.

The lane keeping assist mode and the lane departure control mode may be executed separately from each other or alternatively the lane keeping assist mode may include the lane departure control mode.

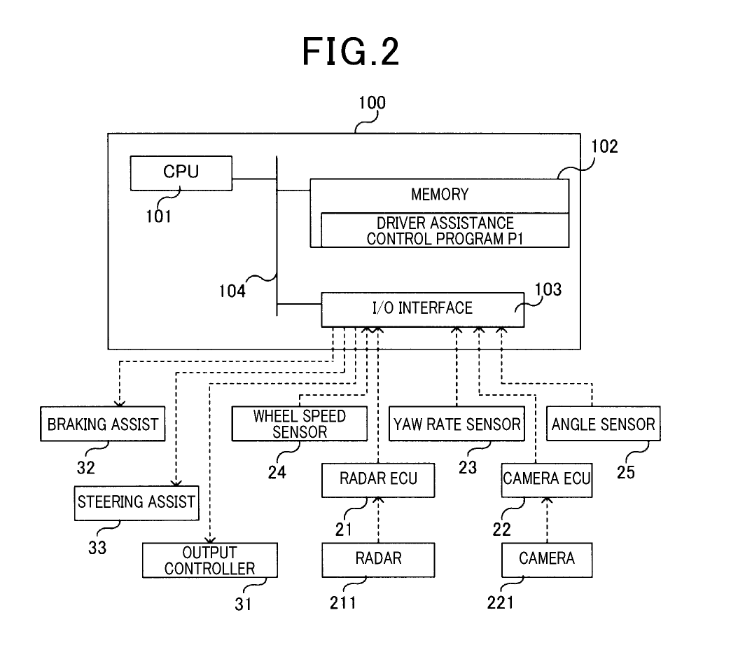

As shown in FIG. 2, the driver assistance control device 100 is provided with a central processing unit (CPU) 101 as a control unit, a memory 102, an input/output interface 103 as an acquiring unit, and a bus 104. The CPU 101, the memory 102, and the input/output interface 103 are connected via a bus so that bidirectional communication is possible. The memory 102 is provided with a memory, for example, a ROM, that stores the driver assistance control program P1 for executing the driver assistance control in a nonvolatile and read-only manner, and a memory, for example, a RAM, that can be read and written by the CPU 101. The CPU 101 functions as a control unit by developing and executing the driver assistance control program P1 stored in the memory 102 in a random access memory. Further, the CPU 101 may be a single CPU, more than one CPU that executes each program, or a multitasking type CPU that can execute more than one program at the same time.

To the input/output interface 103, the radar ECU 21, camera ECU 22, yaw rate sensor 23, wheel speed sensor 24, rotation angle sensor 25, and the output control device 31, braking assistance device 32 and steering assistance device 33 are connected via control signal lines. Detection signals are received from the radar ECU 21, camera ECU 22, yaw rate sensor 23, wheel speed sensor 24, and rotation angle sensor 25; control signals dictating throttle valve opening and control signals dictating fuel injection amount are delivered to the output control device 31; control signals dictating braking level are delivered to the braking assistance device 32; and control signals dictating steering angle are delivered to the steering assistance device 33.

The millimeter wave radar 211 is a sensor that detects the distance, relative speed and angle of the target by emitting millimeter waves and receiving the waves reflected by the target. In the present embodiment, the millimeter wave radar 211 is disposed on each of the center and both sides of the front bumper 520 and both sides of the rear bumper 521. Unprocessed detection signals delivered from the millimeter wave radar 211 are processed in the radar ECU 21 and delivered to the driver assistance control device 100 as detection signals composed of a point or a sequence of points indicating one or more representative positions of the target. Alternatively, without the radar ECU 21 being provided, signals indicating unprocessed receiving waves may be delivered to the driver assistance control device 100 from the millimeter wave radar 211 as detection signals. When unprocessed receiving waves are used as detection signals, signal processing for identifying the position and distance of the target is executed in the driver assistance control device 100.

The camera 221 is a monocular imaging device having one imaging element such as a CCD, and is a sensor that delivers contour information of the target as image data that are detection results by receiving visible light. A feature point extraction process is performed on the image data delivered from the camera 221 in the camera ECU 22, and a pattern indicated by the extracted feature point and a comparative pattern indicating a contour of a target, namely a vehicle, that is to be set to a control target prepared in advance are compared with each other. When, the extracted pattern and the comparative pattern are identical or similar to each other, a frame image including the discriminated target is generated. On the other hand, when the extracted pattern and the comparative pattern are not identical or similar to each other, that is, when the two are dissimilar, the frame image is not generated. In the camera ECU 22, when more than one target is included in the image data, more than one frame image including each of the discriminated targets is generated, and these are delivered to the driver assistance control device 100 as detection signals. Each frame image is represented by pixel data, and includes position information of the discriminated target, that is, coordinate information. The number of frame images that can be included in the detection signals depends on the bandwidth between the camera ECU 22 and the driver assistance control device 100. Without separately providing the camera ECU 22, the unprocessed image data captured by the camera 221 may be delivered to the driver assistance control device 100 as the second detection signals. In this case, discrimination of the target using a contour pattern of the target may be executed in the driver assistance control device 100. In the present embodiment, the camera 221 is disposed at the upper center of the windshield 510. The pixel data delivered from the camera 221 are monochrome pixel data or color pixel data.

The yaw rate sensor 23 is a sensor for detecting the rotational angular velocity of the vehicle 500. The yaw rate sensor 23 is disposed, for example, in the central portion of the vehicle. The detection signals delivered from the yaw rate sensor 23 are voltage values proportional to the rotation direction and angular velocity.

The wheel speed sensor 24 is a sensor for detecting the rotation speed of the wheel 501, and is provided for each wheel 501. The detection signals delivered from the wheel speed sensor 24 are pulse waves indicating voltage values proportional to the wheel speed or intervals depending on the wheel speed. By using the detection signals from the wheel speed sensor 24, information on the vehicle speed, driving distance of the vehicle and the like can be obtained.

The rotation angle sensor 25 is a torque sensor for detecting the amount of torsion generated in the steering rod by steering the steering wheel 504, that is, the steering torque. In the present embodiment, the rotation angle sensor 25 is provided on the steering rod connecting the steering wheel 504 and the steering mechanism. The detection signals delivered from the rotation angle sensor 25 are voltage values proportional to the amount of twist.

The output control device 31 adjusts the opening of the throttle valve and the fuel injection amount in response to the operation of the accelerator pedal by the driver or irrespective of the driver's operation of the accelerator pedal, and is an actuator, for example, a stepping motor or a piezoelectric actuator, for controlling the output of the internal combustion engine ICE. A driver for controlling the operation of the actuator on the basis of the control signals from the CPU 101 is mounted on the output control device 31. In the present embodiment, the output control device 31 is provided in the intake manifold and the cylinder head, and controls the amount of air drawn into the internal combustion engine ICE and the amount of fuel injected into the cylinder of the internal combustion engine ICE in accordance with the control signals from the driver assistance control device 100.

The braking assistance device 32 is an actuator for achieving braking by the braking device 502 irrespective of the braking pedal operation by the driver. Further, a driver for controlling the operation of the actuator on the basis of the control signals from the CPU 101 is mounted on the braking assistance device 32. In the present embodiment, the braking assistance device 32 is provided in the braking line 503, and controls the hydraulic pressure in the braking line 503 in accordance with the control signals from the driver assistance control device 100. The braking assistance device 32 is constituted of a module provided with, for example, an electric motor and a hydraulic piston driven by the electric motor. Alternatively, a brake control actuator already introduced as an anti-skid device or an anti-lock braking system may be used.

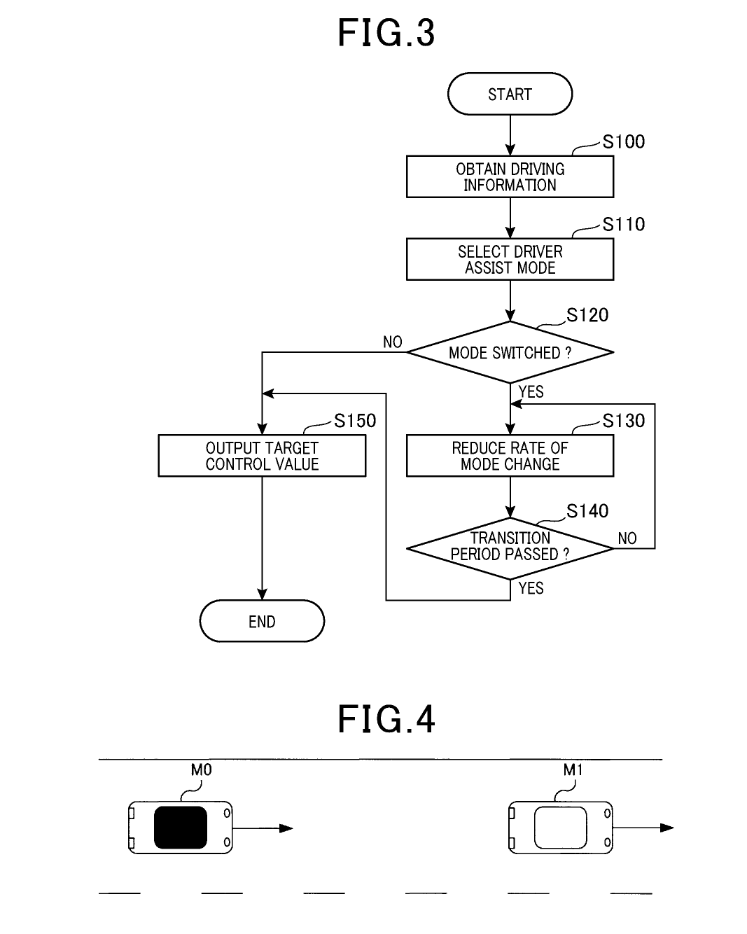

With reference to FIG. 3 and FIG. 4, the driver assistance control process executed by the driver assistance control device 100 according to the first embodiment shall be described. The processing routine shown in FIG. 3 is executed repeatedly at a predetermined time interval, for example, from the start till the end of operation of the control system of a vehicle, or from the time a start switch is turned on till the time the start switch is turned off. The driver assistance control process is executed when the CPU 101 executes the driver assistance control program P1.

The CPU 101 acquires information on the driving conditions of the vehicle and the driving environment surrounding the vehicle (step S100). The information on driving conditions of the vehicle is information relating to the system-equipped vehicle 500, and the information on the driving environment surrounding the vehicle is information relating to objects other than the system-equipped vehicle 500 surrounding the system-equipped vehicle 500, namely targets. The driving conditions of the vehicle include the speed of the vehicle and the direction of the vehicle. The speed of the vehicle is acquired via the wheel speed sensor 24, and the direction of the vehicle is acquired via the yaw rate sensor 23 and the rotation angle sensor 25. The driving environment surrounding the vehicle includes information such as the position, speed and conditions of objects in the front, rear, left and right of the system-equipped vehicle 500. Examples of the objects include, for example, other vehicles, roads, road markings and road signs. The driving environment is acquired by the millimeter wave radars 211 and the camera 221.

The CPU 101 selects one of two of modes of the driver assistance using the acquired driving conditions and driving environment (step S110). The modes of the driver assistance include, for example, constant speed driving assistance process (i.e., the cruise control (CC) mode) that keeps the speed of the system-equipped vehicle 500 at a set speed, assistance process for keeping inter-vehicle distance and vehicle speed (i.e., the adaptive cruise control (ACC) mode) that keeps the inter-vehicle distance (i.e., follow distance) between the system-equipped vehicle 500 and a vehicle traveling ahead constant within the set speed, assistance process for preventing lane departure (i.e., the lane keeping assist (LKAS) mode that assists keeping the driving lane of the system-equipped vehicle 500, and assistance process for changing lanes (i.e., the lane change assist (LCA) mode) that assists changing the driving lane of the system-equipped vehicle 500 to another driving lane. For instance, the CPU 101 selects one of the CC mode and the ACC mode and one of the LKAS mode and the LCA mode. The ACC mode may alternatively include the CC mode. The CC mode and the ACC mode use a parameter (e.g., the speed of the system-equipped vehicle 500) in a direction in which the system-equipped vehicle 500 is heading, while the LKAS mode and the LCA mode use a parameter (e.g., the steered angle of the system-equipped vehicle 500) in a lateral direction of the system-equipped vehicle 500.

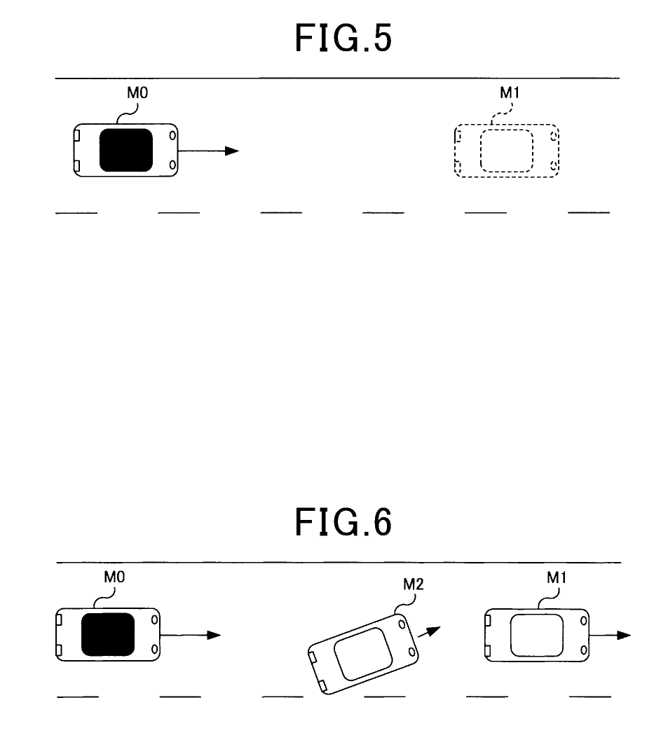

For example, when the driver turns on the ACC main switch disposed on the steering wheel while driving the system-equipped vehicle 500, and sets the speed of the vehicle, the assistance process for keeping inter-vehicle distance and vehicle speed (i.e., the ACC mode) is entered. As demonstrated in FIG. 4, while driving the vehicle M0 (i.e., the system-equipped vehicle 500) at a set speed, and when the vehicle M0 catches up with another vehicle M1 in front and the distance between the vehicle M0 and the other vehicle M1 in front is not more than the detection distance, the assistance process for keeping inter-vehicle distance and vehicle speed is executed. In the assistance process for keeping inter-vehicle distance and vehicle speed, when the inter-vehicle distance between the vehicle M0 and the other vehicle M1 in front approaches a predetermined inter-vehicle distance, the vehicle speed of the vehicle M0 is reduced. When the predetermined inter-vehicle distance is reached, the speed of the vehicle M0 is adjusted so as to keep the predetermined inter-vehicle distance. As a result, the vehicle M0 follows the other vehicle M1 which is in front. Further, the detection distance is a distance at which an object in front can be detected by the millimeter wave radar 211 or the camera 221. On the other hand, as shown in FIG. 5, when the other vehicle M1 in front changes lanes to an adjacent lane and the like and departs from the detection distance of the vehicle M0, assistance process for constant speed driving (i.e., the CC mode) is executed. When the speed of the vehicle M0 at the time of initiating the assistance process for constant speed driving is lower than the speed set by the driver, the speed of the vehicle M0 is increased to the set speed and when the speed reaches the set speed, the set speed is kept. As a result, the vehicle M0 is driven independently while keeping the predetermined speed. Moreover, as shown in FIG. 6, when an interrupting vehicle M2 changes course to between the vehicle M0 and the other vehicle M1 in front while the vehicle M0 is executing the assistance process for keeping inter-vehicle distance and vehicle speed (i.e., the ACC mode), the speed of the vehicle M0 is reduced, and the interrupting vehicle M2 is set as a new preceding vehicle, and the assistance process for keeping inter-vehicle distance and vehicle speed, continues.

As described above, the mode of the driver assistance is determined using the driving environment such as the position and speed of the other vehicle M1. Specifically, in a driving environment in which the millimeter wave radar 211 or the camera 221 can detect the other vehicle M1 in front, the CPU 101 selects the mode of the driver assistance to be the assistance process for keeping inter-vehicle distance and vehicle speed (i.e., the ACC mode). In a driving environment in which the millimeter wave radar 211 or the camera 221 cannot detect the other vehicle M1 in front, the mode of the driver assistance is determined to be assistance process for constant speed driving (i.e., the CC mode).

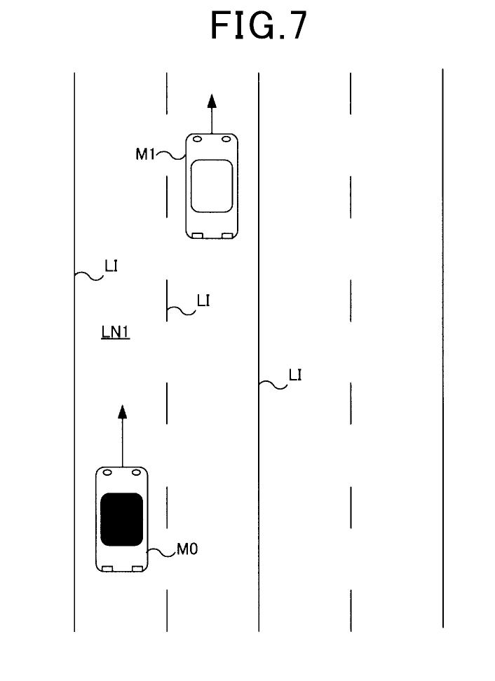

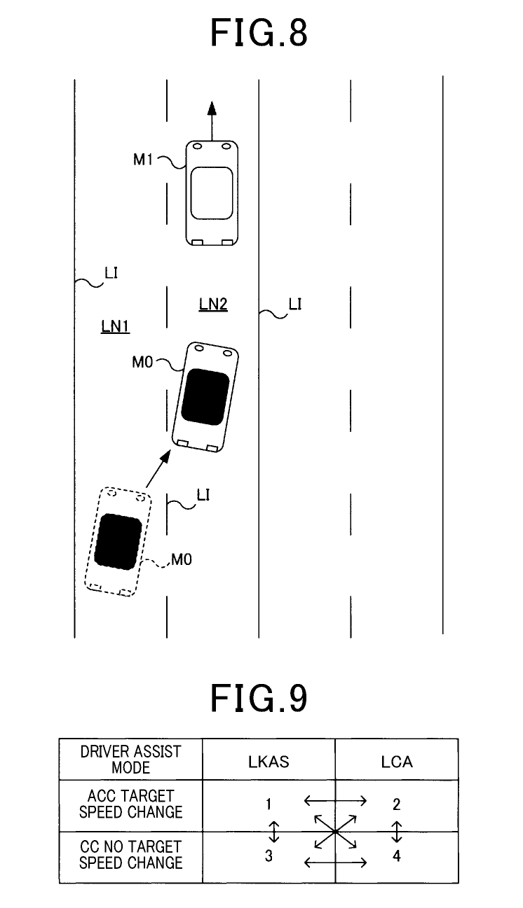

The assistance process for preventing lane departure and the assistance process for changing lanes will be described. For example, when the main switch of the LKAS disposed in the instrument panel is turned on, the assistance process for preventing lane departure can be executed. In the example of FIG. 7, when the vehicle M0 driving on a vehicle traffic zone LA comes close to crossing the mark line LI dividing vehicle traffic zones, the assistance process for preventing lane departure is executed. Further, in general, the vehicle traffic zone LA is also called a (traffic) lane, and a mark line LI dividing vehicle traffic zones is also called a white line or a yellow line. In the assistance process for preventing lane departure, when the vehicle M0 come close to crossing the mark line LI without operating a direction indicator, the steering angle is controlled and steering assistance is executed so that the vehicle M0 is driven at the center of the lane. On the other hand, when the direction indicator is operated, the assistance process for preventing lane departure is temporarily canceled, and steering assistance is not executed and an assistance process for changing lanes is executed. In the assistance process for changing lanes, presence or absence of another vehicle (not shown) at a side and rear of the vehicle M0 is checked in response to the operation of the direction indicator, and when the distance between the other vehicle and the vehicle M0 and the relative speed of the two vehicles are not less than predetermine threshold values, as shown in FIG. 8, the steering angle is controlled from the current lane LN1 towards lane LN2 driven after changing lanes, and the steering assistance is executed so that the vehicle M0 changes lanes to lane LN2 driven after changing lanes. Further, when the destination of the vehicle M0 is set and the driving route is determined, lane change can be executed in accordance with the driving route without depending on the operation of the direction indicator by the driver. That is, depending on the driving route, for example, in the case of a straight driving route, the mode of the driver assistance is determined to be an assistance process for preventing lane departure. In the case of a route before turning right or turning left, since the traffic lane is to be changed to a right lane or a left lane, an assistance process for changing lanes is to be determined.

As described above, the mode of the driver assistance is determined between, for example, the assistance process for preventing lane departure (e.g., the lane departure alert (LDA) mode) and the assistance process for changing lanes (e.g., the lane change assist (LCA) mode) using driving conditions such as operation of a direction indicator or a driving route of the vehicle M0. For instance, when there is an operation of a direction indicator, the mode of the driver assistance is determined to be the assistance process for changing lanes (i.e., LCA mode). Alternatively, when there is no operation of the direction indicator, the mode of the driver assistance is determined to be the assistance process for preventing lane departure (e.g., the lane departure alert (LDA) mode). In the example of FIG. 8, when lane change is made during the execution of the assistance process for keeping inter-vehicle distance and vehicle speed (i.e., the ACC mode), another vehicle M1 will appear in front, so that the speed of the vehicle M0 is reduced. Moreover, although not shown in the drawing, when another vehicle M1 exists in front, lane change is performed during execution of the ACC mode, and when there is no other vehicle M1 in front in lane LN2, the mode of the driver assistance is switched from the ACC mode to the CC mode in which the speed of the vehicle M0 is decreased to a speed set by the driver of the vehicle M0 (i.e., the system-equipped vehicle 500).

After the mode of the driver assistance is determined in step S100, the CPU 101 determines whether a request has been made to change or switch the mode of the driver assistance (step S120). Specifically, it is determined whether the mode of the driver assistance required to be entered in accordance with the driving conditions and the driving environment is different the mode of the driver assistance currently being executed. In the example of FIG. 9, the mode of the driver assistance is switched in one of twelve ways as indicated by arrows. For instance, (1) the mode of the driver assistance is requested to be switched from the lane keeping assist (LKAS) mode to the lane change assist (LCA) mode while the adaptive cruise control (ACC) mode and the LKAS mode are being executed (transition of states 1 to 2 in the table of FIG. 9). (2) The mode of the driver assistance is requested to be switched from the ACC mode to the cruise control (CC) mode while the ACC mode and the LKAS mode are being executed (transition of states 1 to 3 in the table of FIG. 9). (3) The mode of the driver assistance is requested to be switched from the ACC mode to the CC mode and from the LKAS mode to the LCA mode while the LKAS mode and the ACC mode are being executed (transition from states 1 to 4 in the table of FIG. 9). (4) The mode of the driver assistance is requested to be switched from the ACC mode to the CC mode and from LCA mode to the LKAS mode while the ACC mode and the LCA mode are being executed (transition of states 2 to 3 in the table of FIG. 9). (5) The mode of the driver assistance is requested to be switched from the ACC mode to the CC mode while the ACC mode and the LCA mode are being executed (transition of states 2 to 4 in the table of FIG. 9). (6) The mode of the driver assistance is requested to be switched from the LKAS mode to the LCA mode while the LKAS and the CC mode are being executed (transition of states 3 to 4 in the table of FIG. 9). The explanation of mode changes 2 to 1, 3 to 1, 3 to 2, 4 to 1, 4 to 2, and 4 to 3 will be omitted here.

If the mode of the driver assistance has been requested to be changed (step S120: Yes) meaning that one of the mode switches, as demonstrated in the table of FIG. 9, has been requested, the CPU 101 computes a control value, that is, a target control value used in the changed mode of the driver assistance and then decreases the target control value. The CPU 101 outputs the decreased target control value to the target driver assistance unit 31, 32, or 33 (step S130). In the case where the control value (i.e., a controlled parameter) is the speed of the system-equipped vehicle 500, the target control value (i.e., a target value of the controlled parameter) used in the changed mode of the driver assistance is 60 km, and the target control value used in the currently executed mode of the driver assistance is 60 km, the CPU 101 changes 60 km to, for example, 50 km without changing 40 km to 60 km. In other words, the CPU 101 changes or decreases a rate of change from the target control value used in the mode of the driver assistance currently being executed to that used in the mode of the drive assistance requested to be subsequently entered for a first transition period of time which will be described later in detail. The CPU 101 outputs the changed control value a target driver assistance unit (step S130). In the present embodiment, the rate of change of the control value is reduced using a low pass filter (LPF). But other than this, for example, an averaging coefficient that regulates the rate of change of the control value to a predetermined rate, or a change rate reduction process using an average value of change between the current value and the previous value may be executed. The CPU 101 determines whether a preset first transition period has elapsed or not (step S140). Until the first transition period elapses (step S140: No), the CPU 101 continues to output the control value decreased using the low pass filter (S130). Upon lapse of the first transition period (step S140: Yes), the CPU 101 immediately outputs the target control value calculated without being reduced using the low pass filter (step S150). Therefore, after the lapse of the first transition period, the CPUT 101 changes the control value, as used in the first transition period, to the target control value calculated without being reduced.

The first transition period is, for example, one second. The cutoff frequency of the low-pass filter can be set between 0.1 Hz and 1 Hz depending on the driving scene of the vehicle M0. For example, a cutoff frequency of 1 Hz is used under a driving scene of heavy traffic, and a cutoff frequency of 0.1 Hz is used under a driving scene of smooth traffic. In addition, considering slippery road conditions due to rain or snow, a lower cut-off frequency may be used in order to suppress change in control value. The first transition period and the cutoff frequency may be appropriately determined in accordance with the system such as the braking device 502 and the steering device 44 of the vehicle 500 or in accordance with the driving environment including the driving scene of the vehicle M0. For example, the weather information may be received via the mobile communication network or may be determined on the basis of operation of the windshield wiper. The condition of traffic congestion may be determined by receiving congestion information via a mobile communication network or radio, or by using the detected driving environment.

For instance, the main control value in the assistance process for preventing lane departure or the assistance process for changing lanes is the target steering angle delivered to the steering assistance device 33. In the assistance process for preventing lane departure, since the vehicle M0 has only to be kept at the center of a lane, the amount of change and change rate of the target steering angle are small. On the other hand, in the assistance process for changing lanes, since the vehicle M0 is transferred from the current lane LN1 to lane LN2 after lane change, the amount of change and change rate of the target steering angle are large compared with those of the assistance process for preventing lane departure. Therefore, the change of the mode of the driver assistance between the assistance process for preventing lane departure and the assistance process for changing lanes, in particular, the change of the mode of the driver assistance from the assistance process for preventing lane departure to the assistance process for changing lanes is likely to provoke discomfort and anxiety to those in the vehicle M0 (i.e., the vehicle 500).

The main control values in the assistance process for keeping inter-vehicle distance and vehicle speed and the assistance process for constant speed driving are the demand output value delivered to the output control device 31 and the braking command value delivered to the braking assistance device 32. The demand output value includes the fuel injection amount, the intake air amount, and the ignition timing. The braking command value includes the brake hydraulic pressure value applied to the braking line 503, that is, the operation amount of the hydraulic piston. In the assistance process for keeping inter-vehicle distance and vehicle speed, in order to keep a predetermined inter-vehicle distance, the speed of the vehicle M0 is changed in response to the speed of the other vehicle M1. That is, the target speed changes. On the other hand, in the assistance process for constant speed driving, since the speed set by the driver is kept constant, the target speed of the vehicle M0 does not change. Therefore, the change of the mode of the driver assistance between the assistance process for keeping inter-vehicle distance and vehicle speed and the assistance process for constant speed driving involves change of vehicle speed and is likely to provoke discomfort and anxiety to those in the vehicle 500. Typically, when the speed of the vehicle M0 is lower than the speed set by the driver in the execution of the assistance process for keeping inter-vehicle distance and vehicle speed, if the mode of the driver assistance is switched to the assistance process for constant speed driving, acceleration is executed with the set speed as the target speed. On the other hand, when the mode of the driver assistance is switched from the assistance process for constant speed driving to the assistance process for keeping inter-vehicle distance and vehicle speed, the target speed becomes the speed of the other vehicle M1 in front and deceleration is executed.

In any of the cases mentioned above, change of the control value associated with the change of the mode of the driver assistance is determined by the driving conditions and the driving environment, and is independent of the direct operation amount by the driver. Therefore, the change of the control value very often becomes different from the sense of the driver, and is likely to provoke discomfort and anxiety on the part of the driver and other occupants. According to the driver assistance control device 100 according to the present embodiment, change of the mode of the driver assistance is eased during the transition period, that is, change of value from the control value to execute the driver assistance before the change to the control value to execute the driver assistance after the change is suppressed, or change to the target value in accordance with the mode of the driver assistance after the change is suppressed. Therefore, change of vehicle behavior associated with the change of the mode of the driver assistance is suppressed.

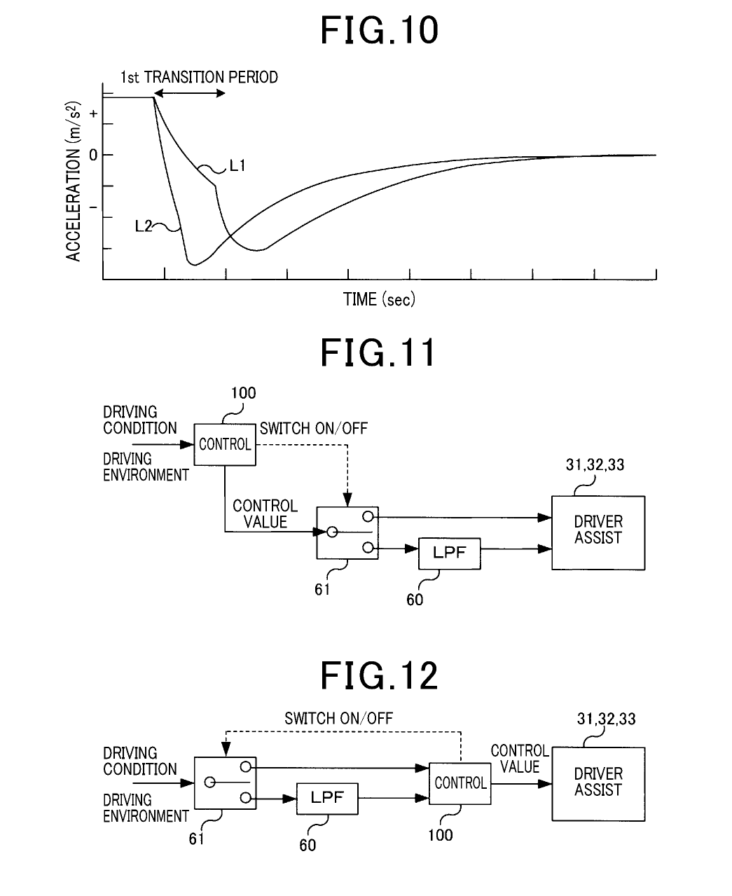

With reference to FIG. 10, the effects of easing the vehicle behavior when the mode of the driver assistance is changed from the assistance process for constant speed driving to the assistance process for keeping inter-vehicle distance and vehicle speed shall be described. In FIG. 10, the vertical axis represents acceleration (m/s²) and the horizontal axis represents time (sec). A characteristic line L1 shows a change in acceleration when a low pass filter is applied and a characteristic line L2 shows a change in acceleration when the low pass filter is not applied. When the change of the control value is eased by using the low pass filter, as indicated by the characteristic line L1 in FIG. 10, the degree of change in the deceleration is reduced and time to reach the target speed associated with a transition to the assistance process for keeping inter-vehicle distance and vehicle speed increases. As a result, change in vehicle speed received by the occupants is eased, and the sense of anxiety and discomfort received by the occupants is reduced or eliminated. Furthermore, after the lapse of the first transition period, the control value computed in the determined assistance process for keeping inter-vehicle distance and vehicle speed is applied, and therefore highly accurate followability to the speed change of the other vehicle M1 in front can be achieved.

Further, the application of the low pass filter to the control value includes both the application to the control value for executing driver assistance determined using the driving conditions and the driving environment as shown in FIG. 11, and the application to the detection values of the driving conditions and the driving environment used for computing the control value as shown in FIG. 12. FIGS. 11 and 12 show the modes of applying the low pass filter using functional blocks. The control unit 100 controls turning on and off of the switch 61 in response to the driving conditions and the driving environment. Turning on the switch 61 corresponds to the application of the low pass filter 60, and turning off the switch 61 corresponds to the non-application of the low pass filter 60.

Returning to FIG. 3, when determining that the mode of the driver assistance mode is not requested to be changed in any of the ways, as demonstrated in FIG. 9 (step S120: NO), the CPU 101 outputs the target control value for executing the determined mode of driver assistance to the target driver assistance unit (Step S150), and ends the process routine. In this case, it is possible to execute quick driver assistance in response to the driving conditions and the driving environment in the mode of the driver assistance in execution.

According to the driver assistance control apparatus 100 according to the first embodiment described above, when the mode of the driver assistance is requested to be changed, the change of the mode of the driver assistance, that is, change of the target control value associated with the change of the mode of the is reduced for the first transition period. Therefore, fluctuation and change in vehicle behavior associated with change in the mode of the driver assistance are suppressed, and the sense of anxiety and discomfort of the occupants including the driver can be reduced or eliminated.

According to the driver assistance control device 100 according to the first embodiment, reduction in change of the target control value used in the mode of the driver assistance is canceled after the lapse of the first transition period. After the lapse of the first transition period, it is possible to execute the driver assistance promptly reflecting the driving conditions and the driving environment using the control value in accordance with the determined, for example, the control value where a low-pass filter is not applied. That is, according to the driver assistance control apparatus 100 according to the first embodiment, the target control value is not reduced at all times. Therefore, for example, there only exists a cutoff frequency when the low pass filter is applied at all times, and a degree of freedom for adjusting the degree of reduction by a coefficient when an averaging coefficient is applied at all times. Therefore, it is not easy to fulfill both the prompt execution of the driver assistance after change and the suppression of the change of vehicle behavior associated with the change of the mode of the driver assistance. On the other hand, according to the driver assistance control apparatus 100 according to the first embodiment, it is possible to fulfill both the reduction or elimination of the sense of anxiety and discomfort of the occupants including the driver caused by the change of vehicle behavior associated with a large change in the control value that is likely to develop at the time of changing the mode of the driver assistance, and prompt switching to and execution of driver assistance in response to the driving conditions and the driving environment.

According to the driver assistance control apparatus 100 according to the first embodiment, when the mode of the driver assistance is not changed, the low pass filter is not applied to the control value. Therefore, it is possible to achieve prompt driver assistance in response to the driving conditions and the driving environment in the mode of the driver assistance in execution. For example, at the time of executing the assistance process for keeping inter-vehicle distance and vehicle speed, it is possible to improve the followability to speed change of the other vehicle M1 in front as compared with the case where the low pass filter is applied. At the time of executing the assistance process for preventing lane departure, it is possible to improve the followability of keeping the center of a lane as compared with the case where the low pass filter is applied.

### Modifications

(1) In the first embodiment, immediately after the lapse of the first transition period, the changed mode of the driver assistance is executed, that is, the reduction in change in the target control value for achieving the changed mode of the driver assistance is cancelled, but after the elapse of the first transition period, and a second transition period may be used to change the target control value to change the control value at a rate different from that used in the first transition period. For example, when the driving environment of the vehicle M0 indicates a condition of a good traffic flow, the chances that the driver on another vehicle M1 in front suddenly puts the brakes on is slim, and therefore even if the margin of inter-vehicle distance is reduced in the assistance process for keeping inter-vehicle distance and vehicle speed, the vehicle M0 and another vehicle M1 will not collide with each other. By adopting the second transition period, it is possible to further suppress the fluctuation of the vehicle behavior and to reduce or eliminate the feeling of anxiety or discomfort of the people riding in the vehicle including the driver. Further, it is desirable that the second transition period is equal to or shorter than the first transition period.
(2) In the first embodiment, the assistance for avoiding a collision is not included in the mode of driver assistance, but avoiding a collision may be included. Assistance for avoiding a collision generally includes assistance for emergency braking and assistance for emergency steering. Emergency means an environment where chances that the system-equipped vehicle 500 contacts or collides with targets such as other vehicles, people, or objects in the streets are high, and where driver assistance is desired to achieve a strong braking force or a large steering angle at a timing earlier than usual. In such a case, avoiding a collision between the system-equipped vehicle 500 and a target should be prioritized over the discomfort of the occupants. Therefore, when the mode of the driver assistance determined in step S110 of FIG. 3 is the emergency assistance for avoiding a collision, the ease measures are not executed. Specifically, the target control value is delivered to the braking assistance device 32 and the steering assistance device 33 without applying a low pass filter to the target control value calculated to achieve the determined mode of the driver assistance.
(3) In the first embodiment, the driver assistance control is achieved from a perspective of software by the CPU 101 executing the driver assistance control program P1, but the driver assistance control can be achieved from a perspective of hardware with a preprogrammed integrated circuit or a discrete circuit.

The present disclosure has been described above on the basis of embodiments and modifications, but the embodiments of the invention described above are for facilitating the understanding of the present disclosure and do not limit the present disclosure. The present disclosure can be modified and improved without departing from the drift and the scope of the claims, and the present disclosure includes equivalents thereof. For example, technical features in the embodiments and the modifications, corresponding to the technical features in each embodiment described in the section of Summary of the invention can be adequately replaced or combined in order to solve part or all of the problems mentioned above, or in order to achieve some or all of the effects mentioned above. Further, unless the technical features are described as essential in the present specification, they can be deleted as appropriate. For example, setting the driver assistance control device of a vehicle according to the first mode mentioned above as application example 1.
[Application example 2] In the driver assistance control device of a vehicle according to application example 1, the control unit makes the driver assistance units execute the driver assistance in accordance with the changed mode of the driver assistance immediately after the lapse of the first transition period.
[Application example 3] In the driver assistance control device of a vehicle according to application example 1, the control unit makes the driver assistance units execute the driver assistance in accordance with the changed mode of the driver assistance after the lapse of the first transition period, and further after the lapse of a predetermined second transition period.
[Application example 4] In the driver assistance control device of a vehicle according to any one of application examples 1 to 3, the first transition period is set depending on the driving environment.
[Application example 5] In the driver assistance control device of a vehicle according to any one of application examples 1 to 4, the mode of the driver assistance comprises assistance with a target vehicle speed change, assistance without a target vehicle speed change, assistance for keeping a driving lane, and assistance for changing driving lanes. The change of the mode of the driver assistance is a change between the assistance with a target vehicle speed change, the assistance without a target vehicle speed change, the assistance for keeping a driving lane, and the assistance for changing driving lanes.
[Application example 6] In the driver assistance control device of a vehicle according to any one of application examples 1 to 5, the mode of the driver assistance comprises an assistance for avoiding a collision. When the change of the mode of the driver assistance is a change to the assistance for avoiding a collision, the change of the mode of the driver assistance is not reduced.

As apparent from the above discussion, the driver assistance control device for use in a vehicle comprises: (a) an acquiring unit (i.e., the input/output interface 103) that acquires given driving conditions of a vehicle and driving environment of the vehicle; and (b) a control unit (i.e., the CPU 101) which selectively performs one of modes of driver assistance including a first driver assistance mode (e.g., the adaptive cruise control (ACC) mode or the lane keeping assist mode (LKAS) mode) and a second driver assistance mode (e.g., the cruise control (CC) mode or the lane change assist (LCA) mode).

The control unit calculates a first target value of a given parameter associated with the driving conditions or the driving environment and achieves the first driver assistance mode using the first target value.

The control unit also calculates a second target value of the same parameter as that used in the first driver assistance mode and achieves the second driver assistance mode using the second target value.

The control unit determines whether the mode of the driver assistance has been requested to be changed from the first driver assistance mode to the second driver assistance mode or not. When such as request is determined to have been made, the control unit calculates a rate of change from the first target value to the second target value and then decreases the rate of change. The control unit initiates the second driver assistance mode and then changes the given parameter from the first target value to the second target value at the decreased rate of change for a given transition period.

1. A driver assistance control device of a vehicle comprising:
an acquiring unit that acquires detected driving conditions of the vehicle and driving environment of the vehicle; and
a control unit that determines a mode of driver assistance depending on at least one of the acquired driving conditions and the driving environment and makes a driver assistance unit execute driver assistance in accordance with the determined mode of the driver assistance,
wherein, when the mode of the driver assistance is changed, the control unit reduces the change of the mode of the driver assistance for a predetermined first transition period.

2. The driver assistance control device of a vehicle according to claim 1, wherein the control unit makes the driver assistance unit execute the driver assistance in accordance with the changed mode of the driver assistance immediately after the lapse of the first transition period.

3. The driver assistance control device of a vehicle according to claim 1, wherein the control unit makes the driver assistance unit execute the driver assistance in accordance with the changed mode of the driver assistance after the lapse of the first transition period, and further after the lapse of a predetermined second transition period

4. The driver assistance control device of a vehicle according to claim 1, wherein the first transition period is set depending on the driving environment.

5. The driver assistance control device of a vehicle according to claim 1, wherein the mode of the driver assistance comprises an assistance with a target vehicle speed change, an assistance without a target vehicle speed change, an assistance for keeping a driving lane, and an assistance for changing driving lanes, and wherein the change of the mode of the driver assistance is a change between the assistance with a target vehicle speed change, the assistance without a target vehicle speed change, the assistance for keeping a driving lane, and the assistance for changing driving lanes.

6. The driver assistance control device of a vehicle according to claim 1, wherein the mode of the driver assistance comprises an assistance for avoiding a collision, and wherein the control unit, when the change of the mode of the driver assistance is a change to the assistance for avoiding a collision, does not reduce the change of the mode of the driver assistance.

7. A driver assistance system comprising:
the driver assistance control device according to claim 1;
a detecting unit that detects the driving conditions of the vehicle and the driving environment of the vehicle; and
said driver assistance unit as set forth in claim 1.

8. A method for driver assistance control of a vehicle comprising the steps of:
acquiring the detected driving conditions of the vehicle and the driving environment of the vehicle;
determining the mode of the driver assistance depending on at least one of the acquired driving conditions and the driving environment; and
when the determined mode of the driver assistance is changed, the change of the mode of the driver assistance is reduced for a predetermined first transition period, and making the driver assistance unit execute the driver assistance in accordance with the determined mode of the driver assistance.
